(19) United States
(12) Patent Application Publication
(10) Pub. No.: US 2009/0198732 A1
(43) Pub. Date: Aug. 6, 2009

(54) METHOD AND SYSTEM FOR DEEP METADATA POPULATION OF MEDIA CONTENT

(75) Inventors: Alexander Ross, Hamburg (DE); Norman Friedenberger, Berlin (DE); Andreas Spechtler, Grodig (AT)

Correspondence Address: REALNETWORKS, INC. C/O STOEL RIVES LLP, 201. S MAIN STREET, SUITE 1100, SALT LAKE CITY, UT, 84111, US

(73) Assignee: RealNetworks, Inc., Seattle, WA (US)

(21) Appl. No.: 12/023,648

(22) Filed: Jan. 31, 2008

(51) Int. Cl. G06F 7/00

(52) U.S. Cl. 707/104.1; 707/E17.009; 707/E17.102

(57) ABSTRACT

Methods and systems generate deep metadata associated with media content. The deep metadata may be used, for example, by media content recommendation systems. In one embodiment, a database includes a plurality of media files that are each associated with respective data models and metadata sets. A new media file is categorized by microgenre and automatically analyzed to generate a new data model. The new data model is compared to the database to determine a particular data model stored therein that satisfies a similarity threshold. In one embodiment, the comparison is limited to data models that are associated with the same microgenre as that of the new media file. A set of metadata associated with the particular data model stored in the database is then assigned to the new media file. In an example embodiment, the new media file is an audio file and the database is a music database.

### TECHNICAL FIELD

This disclosure relates generally to media content recommendation systems and, more particularly, to automatically generating deep metadata associated with media content accessible by media content recommendation systems.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of a system for automatically generating deep metadata associated with media content according to one embodiment;

FIG. 2 graphically illustrates a data structure for an exemplary audio model generated using digital signal processing techniques on a particular song according to one embodiment;

FIG. 3 graphically illustrates a data structure for an exemplary high-level metadata according to one embodiment;

FIG. 4 graphically illustrates an exemplary microgenre list from which a user may select according to one embodiment;

FIG. 5 graphically illustrates an exemplary deep metadata data structure corresponding to an audio data file according to one embodiment;

FIG. 6 is a block diagram that graphically illustrates an exemplary method for adding a microgenre, an audio model, and deep metadata to a new song according to one embodiment;

FIG. 7 is a flow chart illustrating a method for assigning deep metadata to a song according to one embodiment;

FIG. 8 is a block diagram of a media distribution system, a client application, a proxy application, and a personal media device coupled to a distributed computing network according to one embodiment;

FIG. 9 graphically and schematically illustrates the personal media device shown in FIG. 8 according to one embodiment; and

FIG. 10 is a block diagram of the personal media device shown in FIG. 8 according to one embodiment.

### DETAILED DESCRIPTION

Media distribution systems (e.g., the Rhapsody™ service offered by RealNetworks, Inc. of Seattle, Wash.) or media playback systems (e.g., an MP3 player) typically include recommendation systems for providing a list of one or more recommended media content items, such as media content data streams and/or media content files, for possible selection by a user. The list may be generated by identifying media content items based on attributes that are either explicitly selected by a user or implicitly derived from past user selections or observed user behavior. Examples of media content items may include, for instance, songs, photographs, television episodes, movies, or other multimedia content. Several example embodiments disclosed herein are directed to audio (e.g., music) files. However, an artisan will understand from the disclosure herein that the systems and methods may be applied to any audio, video, audio/video, text, animations, and/or other multimedia data.

Associating metadata with media content to facilitate user searches and/or generation of recommendation lists is a time-consuming process. Typically, a user is required to listen to or view a content item and then complete a detailed questionnaire for evaluating the content item with respect to dozens or possibly hundreds of attributes. Today, large databases of metadata are available in many domains of digital content, such as music or film. However, the rapidly increasing amount of digital content being produced makes it increasingly difficult and expensive to keep these databases up to date.

Thus, the methods and systems disclosed herein quickly and easily generate deep metadata associated with media content being added to an existing media database. In one embodiment, a media database includes a plurality of media files that are each associated with respective data models and metadata sets. A new media file is categorized (e.g., by microgenre), after which it is automatically analyzed to generate a new data model. The new data model is compared to the database to determine a particular data model stored therein that satisfies a similarity threshold. In one embodiment, the comparison is limited to data models that are associated with the same category (e.g., microgenre) as that of the new media file. A set of metadata associated with the particular data model stored in the database is then assigned to the new media file without requiring a user to evaluate the media file in detail.

In an example embodiment, the media files are audio files and the database is a music database. The method includes automatically generating a first audio model corresponding to a first audio file. The first audio model may be automatically generated using digital signal processing (DSP) techniques to determine one or more attributes, such as tonality, tempo, rhythm, repeating sections within the first audio file, instrumentation, bass patterns, harmony, and other characteristics know in the art to be ascertainable using (DSP) techniques.

The first audio model is compared to a subset of audio models corresponding to a plurality of stored audio files in the music database. The same DSP techniques used to generate the first audio model may also be used to generate the subset of audio models previously stored in the music database. Selection of the subset may be based on a microgenre assigned to the first audio file. A second audio model is identified from the subset that is similar to the first audio model. The second audio model is associated with a second audio file stored in the database. A set of metadata associated with the second audio file is then assigned to the first audio file. In one such embodiment, the second audio model is more similar to the first audio file than the other audio files in the subset.

In one embodiment, the first audio file and an indication of the assigned set of metadata is stored in the music database. The assigned set of metadata may be used, for example, to recommend the first audio file to a user. In addition, or in other embodiments, the user may be allowed to manually select the microgenre assigned to the first audio file.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

Several aspects of the embodiments described will be illustrated as software modules or components. As used herein, a software module or component may include any type of computer instruction or computer executable code located within a memory device and/or transmitted as electronic signals over a system bus or wired or wireless network. A software component may, for instance, comprise one or more physical or logical blocks of computer instructions, which may be organized as a routine, program, object, component, data structure, etc., that performs one or more tasks or implements particular abstract data types.

In certain embodiments, a particular software component may comprise disparate instructions stored in different locations of a memory device, which together implement the described functionality of the component. Indeed, a component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software components may be located in local and/or remote memory storage devices. In addition, data being tied or rendered together in a database record may be resident in the same memory device, or across several memory devices, and may be linked together in fields of a record in a database across a network.

System Overview

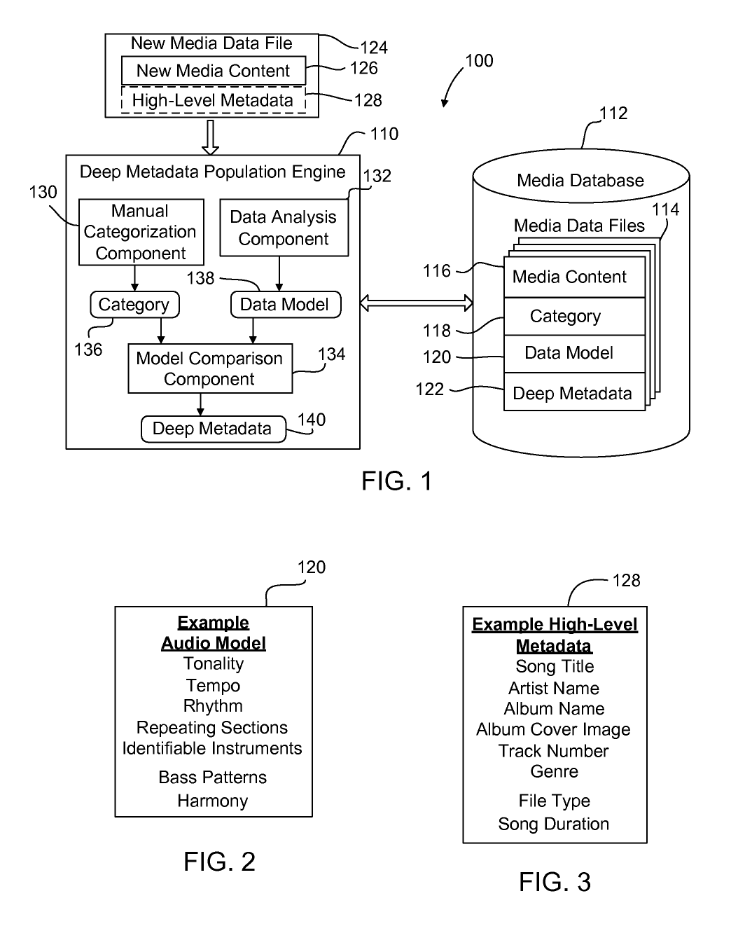

FIG. 1 is a block diagram of a system 100 for automatically generating deep metadata associated with media content according to one embodiment. The system 100 includes a deep metadata population engine 110 in communication with a media database 112. The media database 112 stores a plurality of media data files 114, such as audio data files, video data files, audio/video data files, and/or multimedia data files. Each media data file 114 includes media content 116 and associated information that uniquely describes the media content 116 based on a plurality of attributes. In this example embodiment, the information describing the media content 116 includes a category 118, a data model 120 and deep metadata 122. An artisan will understand from the disclosure herein that the category 118 and/or the data model 120 may be part of the deep metadata 122.

The information associated with the media data files 114 stored in the media database 112 may be generated using manual classification and/or semi-automatic or automatic analysis techniques. For audio files, automatic audio analysis using digital signal processing (DSP) techniques may be capable of generating information for certain media attributes, such as the identification of certain instruments and basic audio patterns. For example, FIG. 2 graphically illustrates a data structure for an exemplary data model 120 (e.g., an audio model 120) generated using DSP techniques for a particular song according to one embodiment. The exemplary audio model 120 shown in FIG. 2 includes DSP generated information for tonality, tempo, rhythm, repeating sections within the song, identifiable instruments (e.g., snares and kick drums), bass patterns, and harmony. An artisan will understand from the disclosure herein that audio analysis may be used to determine other audio parameters, and that FIG. 2 does not represent a complete list. For instance, audio analysis may also be used to estimate attributes, such as a “rap” style or use of a distorted guitar.

DSP techniques, however, generally do not provide adequate data for certain audio attributes, such as a “sad mood” or “cynical lyrics.” Thus, at least a portion of the information associated with the media data files 114 (e.g., the category 118 and deep metadata 122) is generally generated by users involved with compiling the media database 112.

However, if a large number of media data files 114 are added to the media databases 112 in a short period of time, manual classification of the media data files 114 to generate the corresponding deep metadata 122 may not be sufficient. For instance, some commercial music databases currently include approximately 1 million to 2 million songs with an additional 5,000 to 10,000 songs being added each month. It may be difficult and expensive to manually classify and generate deep metadata 122 at such a demanding rate.

Thus, the deep metadata population engine 110 is configured to quickly and accurately associate a new media data file 124 with a corresponding category 136, data model 138, and deep metadata 140 when adding the new media data file 124 to the media database 112. The new media data file 124 includes new media content 126, such as audio, video, and/or multimedia content. In certain embodiments, the new media data file 124 may also include high-level metadata 128 that may be provided, for example, by a publisher or other source of the new media data file 124. As shown in FIG. 3, when the new media data file 124 is an audio file, the high-level metadata may include, for instance, song title, artist name, album name, album cover image, track number, genre, file type and song duration.

The deep metadata population engine 110 includes a manual categorization component 130, an data analysis component 132, and an model comparison component 134. In one embodiment, the manual categorization component 130 allows a user to select or specify a category 136 corresponding to the new media content 126. As discussed above, in certain embodiments the high-level metadata 128 may define a genre corresponding to the new media content 126. For audio files, for example, the genre may be defined as blues, classical, country, dance, folk, jazz, rock, etc. Thus, the category 136 selected by the user may be a microgenre corresponding to the new media content 126. If the high-level metadata 128 does not exist, or if it does not define the genre, the manual categorization component 130 may also allow the user to select the genre. In addition, or in other embodiments, the manual categorization component 130 may allow the user to change the genre defined in the high-level metadata 128 to better correspond to a categorization scheme corresponding to the overall media database 112.

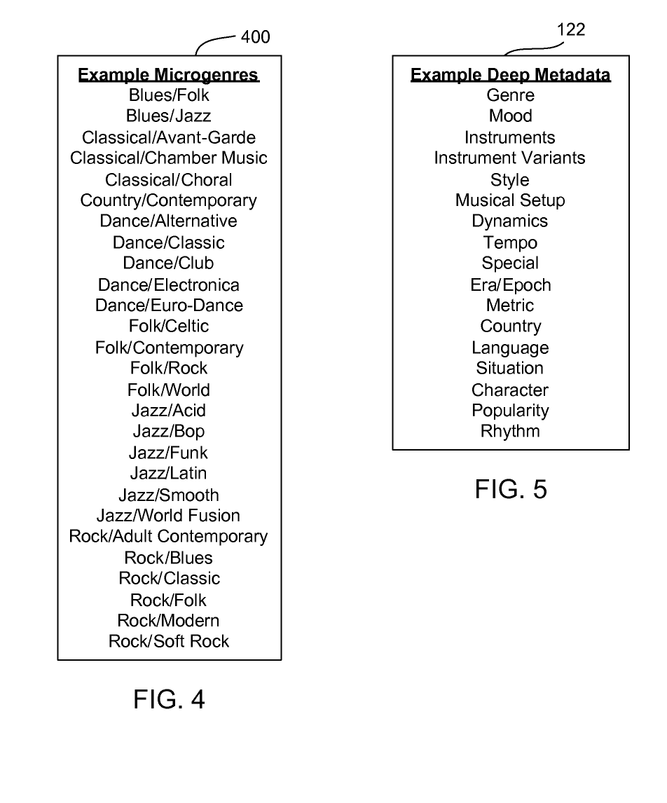

FIG. 4 graphically illustrates an exemplary microgenre list 400 from which the user may select according to one embodiment. The microgenres in the list 400 are shown with their corresponding genres. For example, the “folk” genre may include microgenres, such as “Celtic,” “contemporary,” “rock,” and “world,” as shown in FIG. 4. An artisan will recognize from the disclosure herein that the exemplary microgenre list shown in FIG. 4 is not exhaustive and that many other microgenres may be available for selection.

In one embodiment, the manual categorization component 130 provides a subset of the microgenre list 400 to the user for selection based on the corresponding genre. For instance, if the genre of a particular song is defined as “jazz,” then the manual categorization component 130 allows the user to select a microgenre from a sub-list that may include “acid,” “bop,” “funk,” “Latin,” and “smooth” jazz microgenres.

Returning to FIG. 1, the data analysis component 132 is configured to generate the data model 138 corresponding to the new media content 126. In one embodiment, the data analysis component 132 uses known DSP techniques to determine attributes corresponding to the new media content 126. For audio content, for instance, such attributes may include tonality, tempo, rhythm, repeating sections within the song, identifiable instruments (e.g., snares and kick drums), bass patterns and harmony, as shown in FIG. 2. The data analysis component 132 may also determine other attributes, as is known in the art.

The model comparison component 134 is configured to compare the data model 138 generated by the data analysis component 132 with the data models 120 already stored in the media database 112. In one embodiment, the data analysis component 132 uses the same DSP techniques on the new media data file 124 as those used to generate the data models 120 of the media data files 114 previously stored in the media database 112. Thus, similar media data files 114, 124 have a high probability of having similar data models 120, 138.

The model comparison component 134 searches for and identifies the data model 120 in the media database 112 that is most similar to the data model 138 corresponding to the new media data file 124. The deep metadata population engine 110 then generates the deep metadata 140 corresponding to the new media data file 124 by assigning the deep metadata 122 corresponding to the identified data model 120 in the media database 112 to the new media data file 124. In one embodiment, the deep metadata 140 is a copy of the deep metadata 122 corresponding to the identified data model 120. In another embodiment, the deep metadata 140 is a pointer to the deep metadata 122 corresponding to the identified data model 120 to reduce the amount of redundant information stored in the media database 112. The deep metadata population engine 110 then stores the new media data file 124 with its associated category 136, data model 138, and assigned deep metadata 140 in the media database 112. Thus, the deep metadata population engine 110 associates the deep metadata 140 with the new media data file 124 without the need for a user to manually determine multiple deep metadata attributes.

FIG. 5 graphically illustrates an exemplary deep metadata 122 data structure corresponding to an audio data file according to one embodiment. The exemplary deep metadata 122 includes genre, mood, instruments, instrument variants, style, musical setup, dynamics, tempo, special, era/epoch, metric, country, language, situation, character, popularity and rhythm. An artisan will recognize from the disclosure herein that the exemplary deep metadata 122 shown in FIG. 5 is only a small subset of possible categories of attributes that may be defined for a particular audio data file. Further, an artisan will also recognize that the categories shown in FIG. 5 may each include one or more attributes or subcategories. For example, the instruments category may include a string subcategory, a percussion subcategory, a brass subcategory, a wind subcategory, and/or other musical instrument subcategories. In one example embodiment, approximately 948 attributes are grouped in the 17 categories shown in FIG. 5.

Accordingly, in one embodiment, the model comparison component 134 scans only those data models 120 in the media database 112 that are associated with a category 118 that is the same as the category 136 selected for the new media data file 124. For example, if the user determines that the microgenre of the new media file 124 is Latin jazz, then the model comparison component 134 compares the data model 138 generated by the data analysis component 132 to all of the audio models 120 stored in the media database 112 associated with a Latin jazz microgenre. Scanning only those audio models 120 that are associated with the desired microgenre also increases the probability that the deep metadata population engine 110 will assign an appropriate set of deep metadata 140 to the new media data file 124, while also reducing the scanning time.

If the model comparison component 134 does not find an data model 120 in the media database 112 that is sufficiently similar to the audio model generated by the data analysis component 132, then the deep metadata population engine 110, according to one embodiment, allows the user to manually select the deep metadata 140 corresponding to the new media data file 124. For instance, in one embodiment, if the model comparison component 134 does not find a data model 120 in the media database 112 that satisfies a similarity threshold level, then the deep metadata population engine 110 may flag the new media data file 124 for manual evaluation by a user.

Music Database Example

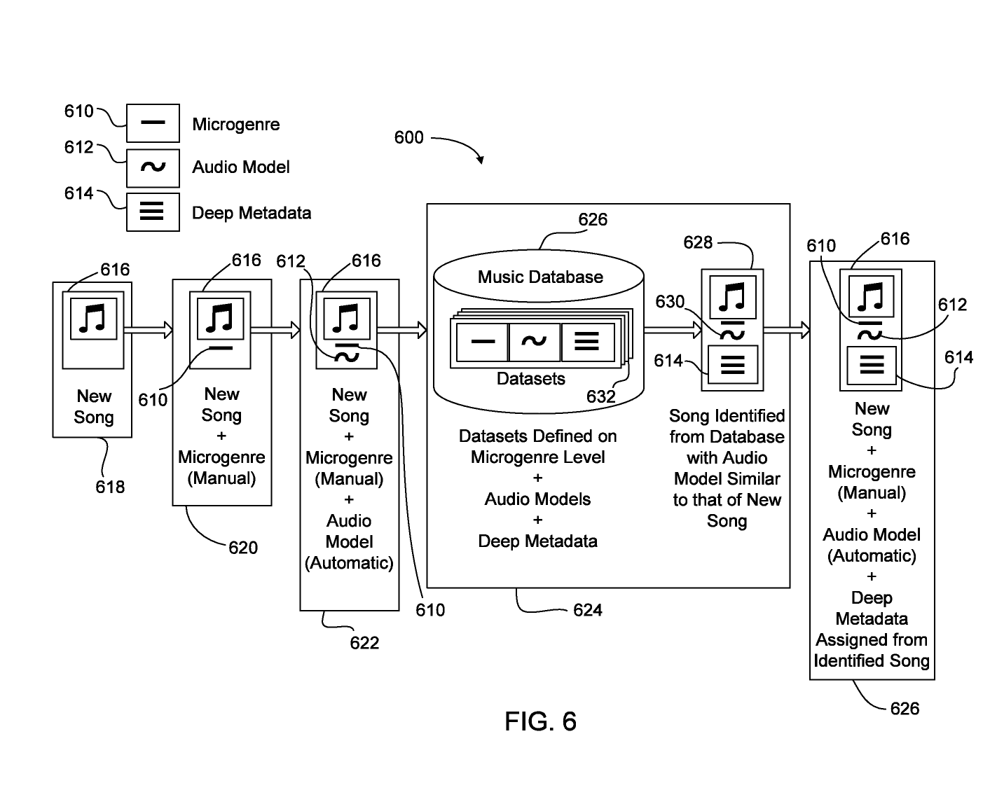

FIG. 6 is a block diagram that graphically illustrates an exemplary method 600 for adding a microgenre 610, an audio model 612, and deep metadata 614 to a new song 616 according to one embodiment. In a block 618, the new song 616 is received. In a block 620, a user manually assigns the microgenre 610 to the new song 616. For example, the user may listen to the new song 616, compare its characteristics to those defined of a plurality of predetermined microgenres, and assign the microgenre 610 that best describes the new song 616. The microgenre 610 for the song 616 may often be determined rapidly, e.g., in a few seconds. In a block 622, the audio model 612 is automatically generated and assigned to the new song 616. As discussed above, the audio model 612 may be generated using known DSP techniques.

In a block 624, a music database 626 is searched to identify a particular song 628 stored therein that has an audio model 630 similar to the audio model 612 of the new song 616. The music database 626 includes a plurality of datasets 632 that are each defined on a microgenre level and include respective audio models and deep metadata. In one embodiment, the music database 626 includes a large number of datasets 632 (e.g., 400,000 or more), each of which contains deep metadata 614 assigned by a human user after listening to or otherwise evaluating an associated song 616. Of course, an artisan will understand from the disclosure herein that more datasets 632 or less datasets 632 may be used in the search. As discussed above, in one embodiment, only those datasets 632 with the same microgenre 610 as that assigned by the user to the new song 616 are searched.

In a block 626, the deep metadata 614 associated with the identified song 628 from the music database 626 is assigned to the new song 616. Although not shown in FIG. 6, in one embodiment, the new song 616 (or a reference thereto), including its assigned microgenre 610, calculated audio model 612, and assigned deep metadata 614, is then stored in the music database 626. Thus, by comparing the new song's audio model 612 with those of a large number of datasets 632, predictions may be made regarding attributes, such as instruments played, technical recording aspects, mood, or other deep metadata characteristics (e.g., see FIG. 5) corresponding to the new song 616. As discussed in detail below, the deep metadata 614 assigned to the new song 616 may then be used to suggest similar songs to a user and/or to identify specific attributes of the new song 616 that the user may or may not prefer (e.g., types of instruments, presence or lack of vocals, etc.). In certain embodiments, explicit or implicit user feedback may also be used to calculate a personal profile for musical tastes.

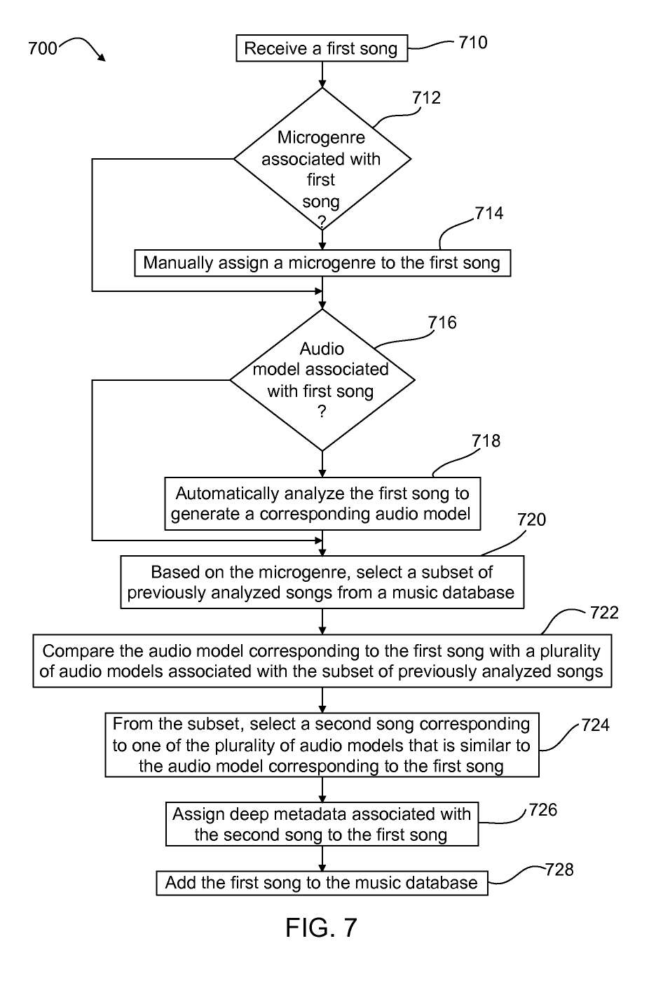

FIG. 7 is a flow chart illustrating a method 700 for assigning deep metadata to a song according to one embodiment. The method 700 may be performed, for example, by the deep metadata population engine 110 shown in FIG. 1 for generating the deep metadata 140 for the new media data file 124. The method 700 begins by receiving 710 a first song and querying 712 whether a microgenre is associated with the first song. If a microgenre is not already associated with the first song, then the method 700 allows a user to manually assign 714 a microgenre to the first song.

The method 700 also queries 716 whether an audio model is associated with the first song. If an audio model is not already associated with the first song, then the method 700 automatically analyzes 718 the first song to generate a corresponding audio model. As discussed above, the audio model may be automatically generated using known DSP techniques.

Based on the microgenre associated with the first song, the method 700 includes selecting 720 a subset of previously analyzed songs from a music database. Each of the previously analyzed songs in the music database is associated with a respective microgenre, an audio model and a set of deep metadata. The selected subset of previously analyzed songs have the same microgenre as that assigned to the first song.

The method 700 then compares 722 the audio model corresponding to the first song with a plurality of audio models associated with the subset of previously analyzed songs. The method 700 also selects 724 a second song from the subset corresponding to one of the plurality of audio models that is similar to the audio model corresponding to the first song. In one embodiment, the second song has a corresponding audio model that is most similar (e.g., as compared to the audio models corresponding to the other songs in the subset) to the audio model corresponding to the first song. Once the second song is identified, the method 700 assigns 726 the deep metadata associated with the second song to the first song and adds 728 the first song to the music database.

Exemplary Media Distribution System

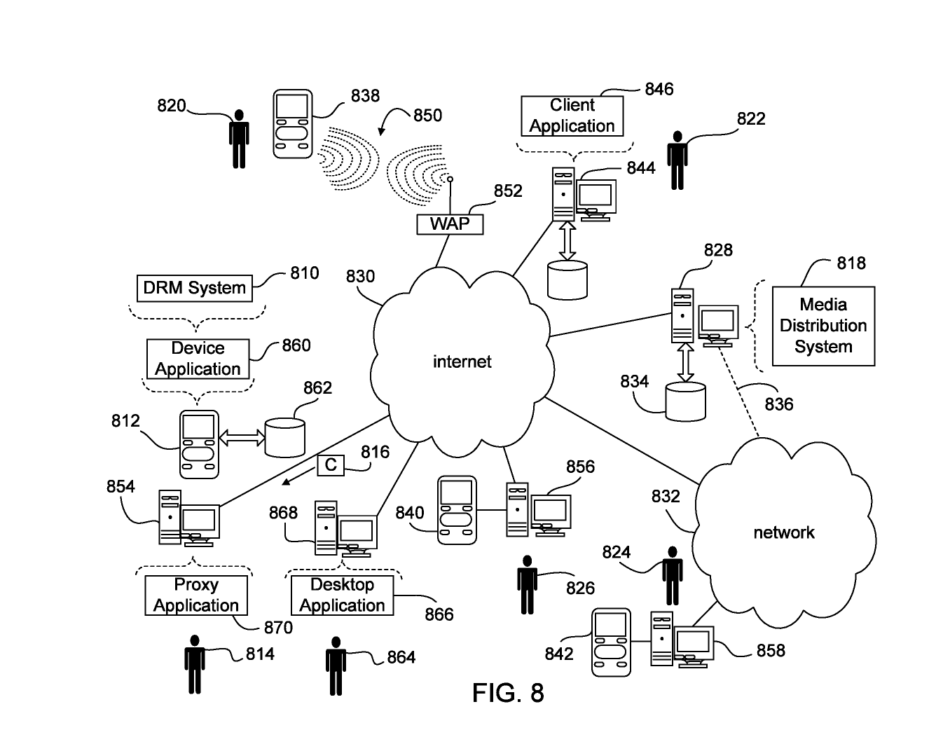

FIGS. 8, 9 and 10 illustrate an exemplary media distribution system and personal media device usable with the categorization and deep metadata population methods and systems described above. The systems and devices illustrated in FIGS. 8, 9 and 10 are provided by way of example only and are not intended to limit the disclosure.

Referring to FIG. 8, there is shown a DRM (i.e., digital rights management) process 810 that is resident on and executed by a personal media device 812. As will be discussed below in greater detail, the DRM process 810 allows a user (e.g., user 814) of the personal media device 812 to manage media content resident on the personal media device 812. The personal media device 812 typically receives media content 816 from a media distribution system 818.

As will be discussed below in greater detail, examples of the format of the media content 816 received from the media distribution system 818 may include: purchased downloads received from the media distribution system 818 (i.e., media content licensed to, e.g., the user 814); subscription downloads received from the media distribution system 818 (i.e., media content licensed to, e.g., the user 814 for use while a valid subscription exists with the media distribution system 818); and media content streamed from the media distribution system 818, for instance. Typically, when media content is streamed from, e.g., a computer 828 to the personal media device 812, a copy of the media content is not permanently retained on the personal media device 812. In addition to the media distribution system 818, media content may be obtained from other sources, examples of which may include but are not limited to files ripped from music compact discs.

Examples of the types of media content 816 distributed by the media distribution system 818 include: audio files (examples of which may include but are not limited to music files, audio news broadcasts, audio sports broadcasts, and audio recordings of books, for example); video files (examples of which may include but are not limited to video footage that does not include sound, for example); audio/video files (examples of which may include but are not limited to a/v news broadcasts, a/v sports broadcasts, feature-length movies and movie clips, music videos, and episodes of television shows, for example); and multimedia content (examples of which may include but are not limited to interactive presentations and slideshows, for example).

The media distribution system 818 typically provides media data streams and/or media data files to a plurality of users (e.g., users 814, 820, 822, 824, 826). Examples of such a media distribution system 818 may include the Rhapsody™ service offered by RealNetworks, Inc. of Seattle, Wash.

The media distribution system 818 is typically a server application that resides on and is executed by a computer 828 (e.g., a server computer) that is connected to a network 830 (e.g., the Internet). The computer 828 may be a web server running a network operating system, examples of which may include but are not limited to Microsoft Windows 2000 Server™, Novell Netware™, or Redhat Linux™.

Typically, the computer 828 also executes a web server application, examples of which may include but are not limited to Microsoft IIS™, Novell Webserver™, or Apache Webserver™, that allows for HTTP (i.e., HyperText Transfer Protocol) access to the computer 828 via the network 830. The network 830 may be connected to one or more secondary networks (e.g., network 832), such as: a local area network; a wide area network; or an intranet, for example.

The instruction sets and subroutines of the media distribution system 818, which are typically stored on a storage device 834 coupled to the computer 828, are executed by one or more processors (not shown) and one or more memory architectures (not shown) incorporated into the computer 828. The storage device 834 may include but is not limited to a hard disk drive, a tape drive, an optical drive, a RAID array, a random access memory (RAM), or a read-only memory (ROM).

The users 814, 820, 822, 824, 826 may access the media distribution system 818 directly through the network 830 or through the secondary network 832. Further, the computer 828 (i.e., the computer that executes the media distribution system 818) may be connected to the network 830 through the secondary network 832, as illustrated with phantom link line 836.

The users 814, 820, 822, 824, 826 may access the media distribution system 818 through various client electronic devices, examples of which may include but are not limited to personal media devices 812, 838, 840, 842, client computer 844, personal digital assistants (not shown), cellular telephones (not shown), televisions (not shown), cable boxes (not shown), internet radios (not shown), or dedicated network devices (not shown), for example.

The various client electronic devices may be directly or indirectly coupled to the network 830 (or the network 832). For instance, the client computer 844 is shown directly coupled to the network 830 via a hardwired network connection. Further, the client computer 844 may execute a client application 846 (examples of which may include but are not limited to Microsoft Internet Explorer™, Netscape Navigator™, RealRhapsody™ client, RealPlayer™ client, or a specialized interface) that allows, e.g., the user 822 to access and configure the media distribution system 818 via the network 830 (or the network 832). The client computer 844 may run an operating system, examples of which may include but are not limited to Microsoft Windows™, or Redhat Linux™.

The instruction sets and subroutines of the client application 846, which are typically stored on a storage device 848 coupled to the client computer 844, are executed by one or more processors (not shown) and one or more memory architectures (not shown) incorporated into the client computer 844. The storage device 848 may include but is not limited to a hard disk drive, a tape drive, an optical drive, a RAID array, a random access memory (RAM), or a read-only memory (ROM).

As discussed above, the various client electronic devices may be indirectly coupled to the network 830 (or the network 832). For instance, the personal media device 838 is shown wireless coupled to the network 830 via a wireless communication channel 850 established between the personal media device 838 and a wireless access point (i.e., WAP) 852, which is shown directly coupled to the network 830. The WAP 852 may be, for instance, an IEEE 802.11a, 802.11b, 802.11g, Wi-Fi, and/or Bluetooth device that is capable of establishing the secure communication channel 850 between the personal media device 838 and the WAP 852. As is known in the art, IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows, e.g., mobile phones, computers, and personal digital assistants to be interconnected using a short-range wireless connection.

In addition to being wirelessly coupled to the network 830 (or the network 832), personal media devices may be coupled to the network 830 (or the network 832) via a proxy computer (e.g., proxy computer 854 for the personal media device 812, proxy computer 856 for the personal media device 840, and proxy computer 858 for the personal media device 842, for example).

Exemplary Personal Media Device

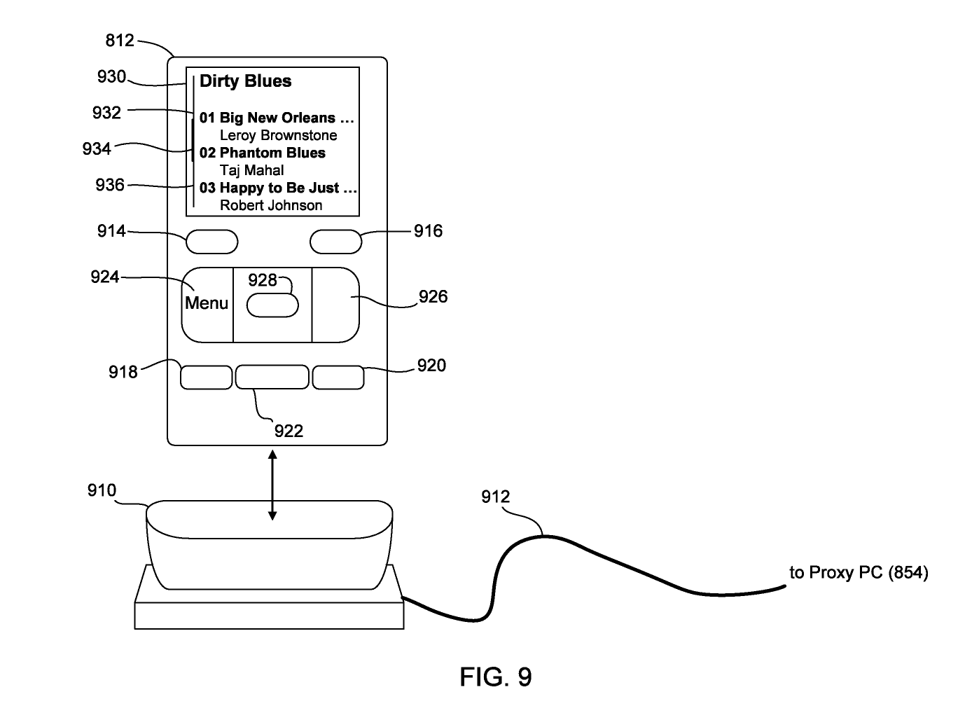

For example and referring also to FIG. 9, the personal media device 812 may be connected to the proxy computer 854 via a docking cradle 910. Typically, the personal media device 812 includes a bus interface (to be discussed below in greater detail) that couples the personal media device 812 to the docking cradle 910. The docking cradle 910 may be coupled (with cable 912) to, e.g., a universal serial bus (i.e., USB) port, a serial port, or an IEEE 1394 (i.e., FireWire) port included within the proxy computer 854. For instance, the bus interface included within the personal media device 812 may be a USB interface, and the docking cradle 910 may function as a USB hub (i.e., a plug-and-play interface that allows for “hot” coupling and uncoupling of the personal media device 812 and the docking cradle 910).

The proxy computer 854 may function as an Internet gateway for the personal media device 812. Accordingly, the personal media device 812 may use the proxy computer 854 to access the media distribution system 818 via the network 830 (and the network 832) and obtain the media content 816. Specifically, upon receiving a request for the media distribution system 818 from the personal media device 812, the proxy computer 854 (acting as an Internet client on behalf of the personal media device 812), may request the appropriate web page/service from the computer 828 (i.e., the computer that executes the media distribution system 818). When the requested web page/service is returned to the proxy computer 854, the proxy computer 854 relates the returned web page/service to the original request (placed by the personal media device 812) and forwards the web page/service to the personal media device 812. Accordingly, the proxy computer 854 may function as a conduit for coupling the personal media device 812 to the computer 828 and, therefore, the media distribution system 818.

Further, the personal media device 812 may execute a device application 860 (examples of which may include but are not limited to RealRhapsody™ client, RealPlayer™ client, or a specialized interface). The personal media device 812 may run an operating system, examples of which may include but are not limited to Microsoft Windows CE™, Redhat Linux™, Palm OS™, or a device-specific (i.e., custom) operating system.

The DRM process 810 is typically a component of the device application 860 (examples of which may include but are not limited to an embedded feature of the device application 860, a software plug-in for the device application 860, or a stand-alone application called from within and controlled by the device application 860). The instruction sets and subroutines of the device application 860 and the DRM process 810, which are typically stored on a storage device 862 coupled to the personal media device 812, are executed by one or more processors (not shown) and one or more memory architectures (not shown) incorporated into the personal media device 812. The storage device 862 may be, for instance, a hard disk drive, an optical drive, a random access memory (RAM), a read-only memory (ROM), a CF (i.e., compact flash) card, an SD (i.e., secure digital) card, a SmartMedia card, a Memory Stick, and a MultiMedia card, for example.

An administrator 864 typically accesses and administers media distribution system 818 through a desktop application 866 (examples of which may include but are not limited to Microsoft Internet Explorer™, Netscape Navigator™, or a specialized interface) running on an administrative computer 868 that is also connected to the network 830 (or the network 832).

The instruction sets and subroutines of the desktop application 866, which are typically stored on a storage device (not shown) coupled to the administrative computer 868, are executed by one or more processors (not shown) and one or more memory architectures (not shown) incorporated into the administrative computer 868. The storage device (not shown) coupled to the administrative computer 868 may include but is not limited to a hard disk drive, a tape drive, an optical drive, a RAID array, a random access memory (RAM), or a read-only memory (ROM).

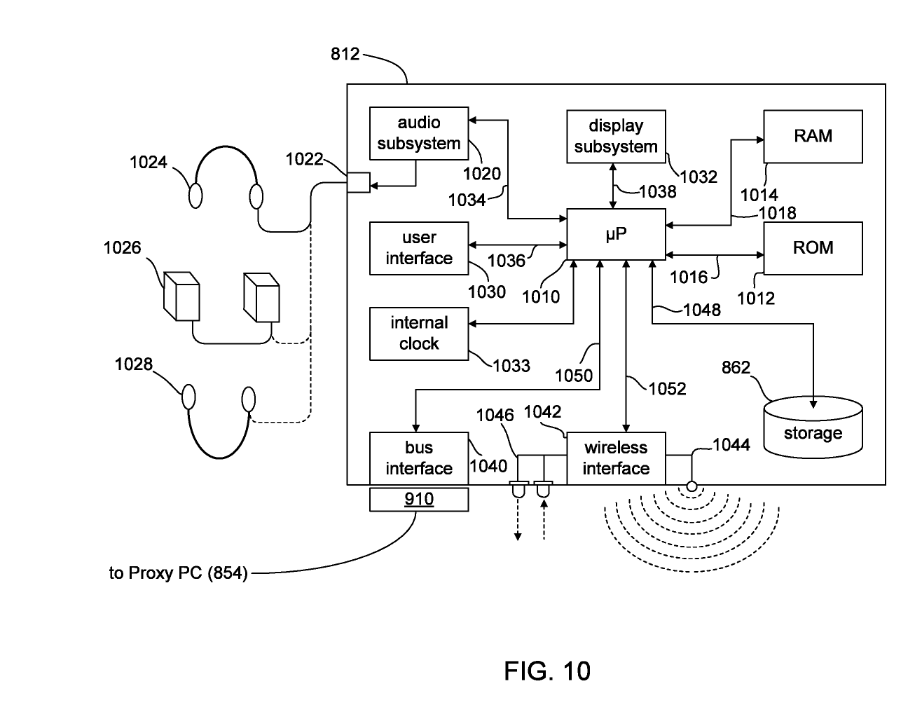

Referring also to FIG. 10, a diagrammatic view of the personal media device 812 is shown. The personal media device 812 typically includes a microprocessor 1010, a non-volatile memory (e.g., read-only memory 1012), and a volatile memory (e.g., random access memory 1014), each of which is interconnected via one or more data/system buses 1016, 1018. The personal media device 812 may also include an audio subsystem 1020 for providing, e.g., an analog audio signal to an audio jack 1022 for removably engaging, e.g., a headphone assembly 1024, a remote speaker assembly 1026, or an ear bud assembly 1028, for example. Alternatively, the personal media device 812 may be configured to include one or more internal audio speakers (not shown).

The personal media device 812 may also include a user interface 1030, a display subsystem 1032, and an internal clock 1033. The user interface 1030 may receive data signals from various input devices included within the personal media device 812, examples of which may include (but are not limited to): rating switches 914, 916; backward skip switch 918; forward skip switch 920; play/pause switch 922; menu switch 924; radio switch 926; and slider assembly 928, for example. The display subsystem 1032 may provide display signals to a display panel 930 included within the personal media device 812. The display panel 930 may be an active matrix liquid crystal display panel, a passive matrix liquid crystal display panel, or a light emitting diode display panel, for example.

The audio subsystem 1020, user interface 1030, and display subsystem 1032 may each be coupled with the microprocessor 1010 via one or more data/system buses 1034, 1036, 1038 (respectively).

During use of the personal media device 812, the display panel 930 may be configured to display, e.g., the title and artist of various pieces of media content 932, 934, 936 stored within the personal media device 812. The slider assembly 928 may be used to scroll upward or downward through the list of media content stored within the personal media device 812. When the desired piece of media content is highlighted (e.g., “Phantom Blues” by “Taj Mahal”), the user 814 may select the media content for rendering using the play/pause switch 922. The user 814 may skip forward to the next piece of media content (e.g., “Happy To Be Just . . . ” by “Robert Johnson”) using the forward skip switch 920; or skip backward to the previous piece of media content (e.g., “Big New Orleans . . . ” by “Leroy Brownstone”) using the backward skip switch 918. Additionally, the user 814 may rate the media content as while listening to it by using the rating switches 914, 916.

As discussed above, the personal media device 812 may include a bus interface 1040 for interfacing with, e.g., the proxy computer 854 via the docking cradle 910. Additionally, and as discussed above, the personal media device 812 may be wireless coupled to the network 830 via the wireless communication channel 850 established between the personal media device 812 and, e.g., the WAP 852. Accordingly, the personal media device 812 may include a wireless interface 1042 for wirelessly-coupling the personal media device 812 to the network 830 (or the network 832) and/or other personal media devices. The wireless interface 1042 may be coupled to an antenna assembly 1044 for RF communication to, e.g., the WAP 852, and/or an IR (i.e., infrared) communication assembly 1046 for infrared communication with, e.g., a second personal media device (such as the personal media device 840). Further, and as discussed above, the personal media device 812 may include a storage device 862 for storing the instruction sets and subroutines of the device application 860 and the DRM process 810. Additionally, the storage device 862 may be used to store media data files downloaded from the media distribution system 818 and to temporarily store media data streams (or portions thereof) streamed from the media distribution system 818.

The storage device 862, bus interface 1040, and wireless interface 1042 may each be coupled with the microprocessor 1010 via one or more data/system buses 1048, 1050, 1052 (respectively).

As discussed above, the media distribution system 818 distributes media content to the users 814, 820, 822, 824, 826 such that the media content distributed may be in the form of media data streams and/or media data files. Accordingly, the media distribution system 818 may be configured to only allow users to download media data files. For example, the user 814 may be allowed to download, from the media distribution system 818, media data files (i.e., examples of which may include but are not limited to MP3 files or AAC files), such that copies of the media data file are transferred from the computer 828 to the personal media device 812 (being stored on storage device 862).

Alternatively, the media distribution system 818 may be configured to only allow users to receive and process media data streams of media data files. For instance, the user 822 may be allowed to receive and process (on the client computer 844) media data streams received from the media distribution system 818. As discussed above, when media content is streamed from, e.g., the computer 828 to the client computer 844, a copy of the media data file is not permanently retained on the client computer 844.

Further, the media distribution system 818 may be configured to allow users to receive and process media data streams and download media data files. Examples of such a media distribution system include the Rhapsody™ and Rhapsody-to-Go™ services offered by RealNetworks™ of Seattle, Wash. Accordingly, the user 814 may be allowed to download media data files and receive and process media data streams from the media distribution system 818. Therefore, copies of media data files may be transferred from the computer 828 to the personal media device 812 (i.e., the received media data files being stored on the storage device 862); and streams of media data files may be received from the computer 828 by the personal media device 812 (i.e., with portions of the received stream temporarily being stored on the storage device 862). Additionally, the user 822 may be allowed to download media data files and receive and process media data streams from the media distribution system 818. Therefore, copies of media data files may be transferred from the computer 828 to the client computer 844 (i.e., the received media data files being stored on the storage device 848); and streams of media data files may be received from the computer 828 by the client computer 844 (i.e., with portions of the received streams temporarily being stored on the storage device 848).

Typically, in order for a device to receive and process a media data stream from, e.g., the computer 828, the device must have an active connection to the computer 828 and, therefore, the media distribution system 818. Accordingly, the personal media device 838 (i.e., actively connected to the computer 828 via the wireless channel 850), and the client computer 844 (i.e., actively connected to the computer 828 via a hardwired network connection) may receive and process media data streams from, e.g., the computer 828.

As discussed above, the proxy computers 854, 856, 858 may function as a conduit for coupling the personal media devices 812, 840, 842 (respectively) to the computer 828 and, therefore, the media distribution system 818. Accordingly, when the personal media devices 812, 840, 842 are coupled to the proxy computers 854, 856, 858 (respectively) via, e.g., the docking cradle 910, the personal media devices 812, 840, 842 are actively connected to the computer 828 and, therefore, may receive and process media data streams provided by the computer 828.

Exemplary User Interfaces

As discussed above, the media distribution system 818 may be accessed using various types of client electronic devices, which include but are not limited to the personal media devices 812, 838, 840, 842, the client computer 844, personal digital assistants (not shown), cellular telephones (not shown), televisions (not shown), cable boxes (not shown), internet radios (not shown), or dedicated network devices (not shown), for example. Typically, the type of interface used by the user (when configuring the media distribution system 818 for a particular client electronic device) will vary depending on the type of client electronic device to which the media content is being streamed/downloaded.

For example, as the embodiment shown in FIG. 9 of the personal media device 812 does not include a keyboard and the display panel 930 of the personal media device 812 is compact, the media distribution system 818 may be configured for the personal media device 812 via proxy application 870 executed on the proxy computer 854.

The instruction sets and subroutines of the proxy application 870, which are typically stored on a storage device (not shown) coupled to the proxy computer 854, are executed by one or more processors (not shown) and one or more memory architectures (not shown) incorporated into the proxy computer 854. The storage device (not shown) coupled to the proxy computer 854 may include but is not limited to a hard disk drive, a tape drive, an optical drive, a RAID array, a random access memory (RAM), or a read-only memory (ROM).

Additionally and for similar reasons, personal digital assistants (not shown), cellular telephones (not shown), televisions (not shown), cable boxes (not shown), internet radios (not shown), and dedicated network devices (not shown) may use the proxy application 870 executed on the proxy computer 854 to configure the media distribution system 818.

Further, the client electronic device need not be directly connected to the proxy computer 854 for the media distribution system 818 to be configured via the proxy application 870. For example, assume that the client electronic device used to access the media distribution system 818 is a cellular telephone. While cellular telephones are typically not physically connectable to, e.g., the proxy computer 854, the proxy computer 854 may still be used to remotely configure the media distribution system 818 for use with the cellular telephone. Accordingly, the configuration information (concerning the cellular telephone) that is entered via, e.g., the proxy computer 854 may be retained within the media distribution system 818 (on the computer 828) until the next time that the user accesses the media distribution system 818 with the cellular telephone. At that time, the configuration information saved on the media distribution system 818 may be downloaded to the cellular telephone.

For systems that include keyboards and larger displays (e.g., the client computer 844), the client application 846 may be used to configure the media distribution system 818 for use with the client computer 844.

Various systems and methods of categorizing media content and assigning deep metadata associated with media content are described above. These systems and methods may be part of a music recommendation system that is implemented on one or more of a client electronic device (e.g., the personal media device 812, the client computer 844 and/or the proxy computer 854) and the media distribution system 818 (see FIG. 8), for instance, as described above. The systems and methods may be implemented using one or more processes executed by the personal media device 812, the client computer 844, the proxy computer 854, the server computer 828, the DRM system 810, and/or the media distribution system 818, for instance, in the form of software, hardware, firmware or a combination thereof. Each of these systems and methods may be implemented independently of the other systems and methods described herein. As described above, the personal media device 812 may include a dedicated personal media device (e.g., an MP3 player), a personal digital assistant (PDA), a cellular telephone, or other portable electronic device capable of rendering digital media data.

Various modifications, changes, and variations apparent to those of skill in the art may be made in the arrangement, operation, and details of the methods and systems of the disclosure without departing from the spirit and scope of the disclosure. Thus, it is to be understood that the embodiments described above have been presented by way of example, and not limitation, and that the invention is defined by the appended claims.

What is claimed is:

1. A method for assigning metadata to an audio file, the method comprising:
automatically generating a first audio model corresponding to a first audio file;
comparing the first audio model to a subset of audio models corresponding to a plurality of stored audio files in a database, the subset based on a microgenre assigned to the first audio file;
identifying a second audio model from the subset that is similar to the first audio model, the second audio model being associated with a second audio file stored in the database; and
automatically assigning a set of metadata associated with the second audio file to the first audio file.

2. The method of claim 1, wherein identifying the second audio model comprises determining that the second audio model is more similar to the first audio model than any other audio model in the subset.

3. The method of claim 1, further comprising storing the first audio file and an indication of the assigned set of metadata in the database.

4. The method of claim 1, further comprising recommending the first audio file to a user based on the assigned set of metadata.

5. The method of claim 1, wherein automatically generating the first audio model comprises determining one or more attributes of the first audio file using a digital signal processing technique.

6. The method of claim 5, wherein the one or more attributes determined using the digital signal processing technique are selected from the group comprising tonality, tempo, rhythm, repeating sections within the audio file, instrumentation, bass patterns, and harmony.

7. The method of claim 5, wherein the same digital signal processing technique was to generate the subset of audio models corresponding to the plurality of stored audio files in the database.

8. The method of claim 1, further comprising allowing a user to manually define the microgenre assigned to the first audio file.

9. A computer accessible medium comprising program instructions for causing a computer to perform a method for assigning metadata to an audio file, the method comprising:
determining, without human intervention, a first audio model corresponding to a first audio file;
comparing the first audio model to a specified subset of audio models corresponding to a plurality of stored audio files in a database, the audio models of the subset being previously determined without human intervention;
locating a second audio model from the subset that is similar to the first audio model, the second audio model being associated with a second audio file stored in the database; and
assigning, without human intervention, a set of metadata associated with the second audio file to the first audio file, the set of metadata associated with the second audio file being previously assigned by a human user.

10. The computer accessible medium of claim 9, wherein identifying the second audio model comprises determining that the second audio model is more similar to the first audio model than any other audio model in the subset.

11. The computer accessible medium of claim 9, the method further comprising storing the first audio file and an indication of the assigned set of metadata in the database.

12. The computer accessible medium of claim 9, the method further comprising recommending the first audio file to a user based on the assigned set of metadata.

13. The computer accessible medium of claim 9, wherein automatically generating the first audio model comprises determining one or more attributes of the first audio file using a digital signal processing technique.

14. The computer accessible medium of claim 13, wherein the one or more attributes determined using the digital signal processing technique are selected from the group comprising tonality, tempo, rhythm, repeating sections within the audio file, instrumentation, bass patterns, and harmony.

15. The computer accessible medium of claim 13, the method further comprising using the digital signal processing technique to generate the subset of audio models corresponding to the plurality of stored audio files in the database.

16. The computer accessible medium of claim 9, the method further comprising allowing a user to manually define a microgenre used to specify the subset of audio models compared with the first audio model.

17. A system for categorizing music, the system comprising:
a music database comprising:
audio content;
audio models associated with respective audio content; and
metadata associated with respective audio content; and
a metadata population engine to assign a set of metadata to a new audio file, the metadata population engine comprising:
an audio analysis component to generate a new audio model corresponding to the new audio file; and
an audio model comparison component to identify a particular audio model from the music database that is similar to the new audio model, the set of metadata assigned to the new audio file being associated with the particular audio model.

18. The system of claim 17, wherein the metadata population engine further comprises a manual categorization component to allow a user to assign a microgenre corresponding to the new audio file.

20. The system of claim 18, wherein the particular audio model identified by the model comparison component is associated with the selected microgenre.

21. A system comprising:
means for generating a first data model corresponding to a media data file;
means for comparing the first data model to a plurality of second data models, the comparison identifying a particular second data model that satisfies a threshold level of similarity to the first data model; and
means for assigning a set of metadata associated with the particular second data model to the media data file.

22. The system of claim 21, further comprising means for allowing a user to manually select a category corresponding to the media data file.

23. The system of claim 22, wherein the plurality of second data models correspond to the selected category.

24. A method for assigning metadata to a media data file, the method comprising:
automatically generating a first data model corresponding to a first media file;
comparing the first data model to a subset of data models corresponding to a plurality of stored media files in a database;
identifying a second data model from the subset that is similar to the first data model, the second data model being associated with a second media file stored in the database; and
assigning a set of metadata associated with the second media file to the first media file.

25. The method of claim 24, wherein the subset is based on a category manually assigned to the first media file.
